(19) United States
(12) Patent Application Publication
(10) Pub. No.: US 2026/0286183 A1
(43) Pub. Date: Sep. 24, 2026

(54) POLISHING COMPOSITION AND POLISHING METHOD

(71) Applicant: FUJIMI INCORPORATED, Kiyosu-shi (JP)

(72) Inventor: Ryota Mae, Kiyosu-shi (JP)

(73) Assignee: FUJIMI INCORPORATED, Kiyosu-shi (JP)

(21) Appl. No.: 19/546,627

(22) Filed: Feb. 23, 2026

(30) Foreign Application Priority Data
Mar. 19, 2025 (JP) 2025-044827

(51) Int. Cl. C09G 1/02; B24B 37/04; C09K 3/14

(52) U.S. Cl. CPC C09G 1/02; B24B 37/044; C09K 3/1409

(57) ABSTRACT

The present disclosure provides a polishing composition which has an excellent step elimination ability on an object to be polished, which enhances the ratio (selection ratio) of the polishing removal rate of a material having silicon-silicon bonds to the polishing removal rate of a material having silicon-nitrogen bonds, and which is also excellent in scratch reduction on a surface of a polished object to be polished. The present disclosure relates to a polishing composition containing (A) at least one selected from the group consisting of a water-soluble polymer having a lactam structure and a water-soluble polymer having a cellulose structure, and (B) an inorganic salt, wherein the electrical conductivity is 1 mS/cm or more and 50 mS/cm or less, the total concentration of sodium ions and potassium ions is 1000 ppm by mass or less, and the pH is 8 or more and 12 or less.

### CROSS-REFERENCE TO RELATED APPLICATION

The entire disclosure of Japanese Patent Application No. 2025-044827 filed on Mar. 19, 2025, is incorporated herein by reference in its entirety.

### TECHNICAL FIELD

The present disclosure relates to a polishing composition and a polishing method.

### BACKGROUND ART

In general, very fine patterning technologies are used for, for example, manufacturing of semiconductor devices, according to recent miniaturization and densification. Wires constituting semiconductor devices are, for example, multi-layered, thereby more complicating surface structures of semiconductor elements after stacking and also more increasing initial steps in surface films. Flattening technologies utilized for removal of initial steps in specified films formed on substrates include chemical mechanical polishing (CMP) processes. In a case where objects to be polished by CMP have silicon-containing materials, polishing compositions for such silicon-containing materials are applied.

For example, International Publication No. WO2024/171892 discloses a polishing composition to be used for polishing a silicon wafer.

### SUMMARY

For example, when a film including a silicon-containing material having a specified initial step is polished to perform polishing of a height portion (thickness X (Å)) of the initial step at a polishing removal rate V (Å/min), the step is eliminated by polishing for X/V (min) as long as only an upper surface of a protruded portion of the step is selectively polished. However, in practice, a bottom of a depressed portion of the step is also progressively polished at a lower rate than that of the upper portion of the protruded portion of the step, due to chemical etching in a CMP process, deflection of a polishing pad, or the like.

A polishing composition for a silicon-containing material is also demanded to have a step elimination efficiency closer to 1 (allowing only an upper surface of a protruded portion to be more selectively polished), as an excellent polishing composition. The step elimination efficiency is here determined as “(the amount (Å) of a height portion eliminated of a step, by polishing in a certain polishing process (in one depressed portion, the height (Å) from the lowest portion of the depressed portion to the uppermost portion of a protruded portion constituting the depressed portion))/(the total amount of polishing in the polishing process (the distance (Å) from the height of the uppermost portion of the above protruded portion before polishing to the height of the uppermost portion of the above protruded portion after polishing))”.

Meanwhile, the polishing composition disclosed in International Publication No. WO2024/171892 is still insufficient in terms of polishing characteristics of an object to be polished including a silicon-containing material (for example, a material having silicon-silicon bonds), in particular, performance about the step elimination efficiency, and there is room for improvement from this viewpoint. For example, it is also demanded to enhance the ratio (selection ratio) of the polishing removal rate of a material having silicon-silicon bonds to the polishing removal rate of a material having silicon-nitrogen bonds and reduce scratches on a surface of a polished object to be polished.

An object of the present disclosure is then to provide a polishing composition which has an excellent step elimination ability on an object to be polished, which enhances the ratio (selection ratio) of the polishing removal rate of a material having silicon-silicon bonds to the polishing removal rate of a material having silicon-nitrogen bonds, and which is also excellent in scratch reduction on a surface of a polished object to be polished.

The inventor of the present disclosure has made intensive studies in order to solve the above problems. As a result, the inventor has found that the above problems are solved by a polishing composition containing (A) at least one selected from the group consisting of a water-soluble polymer having a lactam structure and a water-soluble polymer having a cellulose structure, and (B) an inorganic salt, in which the electrical conductivity is 1 mS/cm or more and 50 mS/cm or less, the total concentration of sodium ions and potassium ions is 1000 ppm by mass or less, and the pH is 8 or more and 12 or less, thereby leading to completion of the invention of the present disclosure.

### DESCRIPTION OF EMBODIMENTS

The present disclosure relates to a polishing composition containing (A) at least one selected from the group consisting of a water-soluble polymer having a lactam structure and a water-soluble polymer having a cellulose structure, and (B) an inorganic salt, wherein the electrical conductivity is 1 mS/cm or more and 50 mS/cm or less, the total concentration of sodium ions and potassium ions is 1000 ppm by mass or less, and the pH is 8 or more and 12 or less. The polishing composition according to the present disclosure, which has such a configuration, has an excellent step elimination ability on an object to be polished, enhances the ratio (selection ratio) of the polishing removal rate of a material having silicon-silicon bonds to the polishing removal rate of a material having silicon-nitrogen bonds, and is also excellent in scratch reduction on a surface of a polished object to be polished.

Hereinafter, embodiments of the present disclosure are described. The present disclosure is not limited only to the following embodiments.

Herein, operations, and measurement of physical properties and the like are performed under conditions of room temperature (20° C. or more and 25° C. or less) and a relative humidity of 40% RH or more and 50% RH or less, unless particularly noted.

Herein, “X or more and Y or less” is used to mean that numerical values (X and Y) described before and after this range are included as the lower limit value and the upper limit value. In a case where a plurality of descriptions “X or more and Y or less” is made, for example, in a case where “X1 or more and Y1 or less, or X2 or more and Y2 or less” is described, all of the disclosure where each numerical value is adopted as the upper limit, the disclosure where each numerical value is adopted as the lower limit, and the disclosure of any combination of such upper limit and lower limit are made (namely, these serve as legitimate bases for amendments). Specifically, all of respective amendments to X1 or more, Y2 or less, X1 or less, Y2 or more, X1 or more and X2 or less, and X1 or more and Y2 or less need to be deemed to be legitimate.

Throughout the description, unless particularly stated otherwise, any expression in a singular form should be understood to encompass the concept of its plural form. Therefore, unless particularly stated otherwise, the article specifying a single form (for example, “a”, “an”, “the”, and the like in the case of English language) should be understood to encompass the concept of its plural form. Further, unless particularly stated otherwise, any term used in the present description should be understood as a term that is used to have the meaning conventionally used in the relevant technical field. Therefore, unless defined otherwise, all the technical terms and scientific terms used in the present description have the same meaning as generally understood by a person ordinarily skilled in the art to which the present invention is pertained. If there is any conflict in meaning, the present description (including the definitions) takes priority.

It is to be understood that all combinations of embodiments and descriptions disclosed herein are disclosed in the present application. In other words, it is to be understood that these combinations can serve as bases for amendments.

### [(A) Water-Soluble Polymer Having Lactam Structure, Water-Soluble Polymer Having Cellulose Structure]

The polishing composition according to the present disclosure contains (A) at least one selected from the group consisting of a water-soluble polymer having a lactam structure and a water-soluble polymer having a cellulose structure (hereinafter, also simply referred to as (A) component). The (A) component adsorbs to a surface of an object to be polished by hydrogen bonding or hydrophobic interaction, thereby forming a protective film. While this formation of the protective film occurs competitively with peeling of the protective film by polishing, the protective film is hardly peeled on a depressed portion as compared with a protruded portion and therefore it is considered that the polishing removal rate of the depressed portion is kept lower than the polishing removal rate of the protruded portion and the step elimination ability is enhanced. In other words, it is considered that the (A) component functions as an additive for step elimination. The (A) component can also have the function of reducing scratches on a surface of a polished object to be polished.

The (A) component may be used singly or in combinations of two or more kinds thereof. The (A) component used here may be a synthetic product or a commercially available product.

### <Water-Soluble Polymer Having Lactam Structure>

The “lactam structure” herein can encompass α-lactam structure, a γ-lactam structure, a δ-lactam structure, an ε-caprolactam or any other lactam structure. The water-soluble polymer having a lactam structure can be synthesized with a monomer containing a lactam structure. The “monomer containing a lactam structure” herein can encompass a monomer in which a nitrogen atom on lactam is provided with a polymerizable group (for example, vinyl group).

The water-soluble polymer having a lactam structure can encompass a polymer (homopolymer) of the monomer containing a lactam structure, a copolymer of two or more monomers containing a lactam structure, and a copolymer of the monomer containing a lactam structure and any other monomer. Examples of such any other monomer can include vinyl alcohol, vinyl acetate, or any other suitable monomer. In an embodiment in which the water-soluble polymer having a lactam structure is a copolymer, the type of the copolymer is not particularly limited, and may be, for example, a block copolymer, a random copolymer, a graft copolymer, an alternate copolymer, a periodic copolymer, or any other type of copolymer.

In some embodiments, the water-soluble polymer having a lactam structure is a homopolymer (polylactam) of a monomer containing a lactam structure. Preferred specific examples of the polylactam include at least one selected from the group consisting of polyvinylpyrrolidone (PVP), polyvinylcaprolactam, polyvinylvalerolactam, polyvinyllaurolactam, and polyvinylpiperidone. In particular, polyvinylpyrrolidone is more preferred.

### <Water-Soluble Polymer Having Cellulose Structure>

Specific examples of the water-soluble polymer having a cellulose structure include methylhydroxyethylcellulose, methylhydroxypropylcellulose, hydroxymethylcellulose, hydroxyethylcellulose, hydroxypropylcellulose, methylcellulose, carboxymethylcellulose, carboxyethylcellulose, carboxymethylhydroxyethylcellulose, or any salt thereof (for example, a lithium salt, a sodium salt, a potassium salt, a magnesium salt, a calcium salt, and an ammonium salt). Herein, in a case where such a salt is used, it is necessary to select the type and the concentration of the water-soluble polymer so that the total concentration of sodium ions and potassium ions falls within the range in the present disclosure.

Among such water-soluble polymers having a cellulose structure, at least one selected from the group consisting of hydroxymethylcellulose, hydroxyethylcellulose, methylcellulose, and carboxymethylcellulose is preferred, and hydroxyethylcellulose is more preferred.

The lower limit of the weight average molecular weight (Mw) of the (A) component is preferably 1,000 or more, more preferably 3,000 or more, further preferably more than 5,000, particularly preferably 8,000 or more, most preferably 10,000 or more. The upper limit of the weight average molecular weight (Mw) of the (A) component is preferably 1,000,000 or less, more preferably 500,000 or less, further preferably 300,000 or less, particularly preferably 150,000 or less, most preferably less than 150,000. In other words, the weight average molecular weight (Mw) of the (A) component is preferably 1,000 or more and 1,000,000 or less, more preferably 3,000 or more and 500,000 or less, further preferably more than 5,000 and 300,000 or less, particularly preferably 8,000 or more and 150,000 or less, most preferably 10,000 or more and less than 150,000. The weight average molecular weight (Mw) of the (A) component can be measured as a value in terms of polyethylene glycol by use of gel permeation chromatography (GPC). The detail of the measurement method is described in Examples below.

The concentration (content) of the (A) component in the polishing composition is not particularly limited, and is preferably 0.001% by mass or more, more preferably 0.003% by mass or more, further preferably 0.005% by mass or more, particularly preferably 0.01% by mass or more under the assumption that the total mass of the polishing composition is 100% by mass. The concentration (content) of the (A) component in the polishing composition is not particularly limited, and is preferably 2% by mass or less, more preferably 1% by mass or less, further preferably 0.5% by mass or less, particularly preferably 0.1% by mass or less under the assumption that the total mass of the polishing composition is 100% by mass.

In other words, the concentration (content) of the (A) component in the polishing composition is preferably 0.001% by mass or more and 2% by mass or less, more preferably 0.003% by mass or more and 1% by mass or less, further preferably 0.005% by mass or more and 0.5% by mass or less, particularly preferably 0.01% by mass or more and 0.1% by mass or less under the assumption that the total mass of the polishing composition is 100% by mass.

When the concentration (content) of the (A) component is in such a range, a polishing composition which is more excellent in step elimination ability and which more reduces scratches on a surface of a polished object to be polished can be obtained. In a case where the polishing composition contains two or more such (A) components, the concentration (content) of the (A) component means the total amount of such (A) components.

### <Other Water-Soluble Polymer>

The polishing composition according to the present disclosure may further contain any other water-soluble polymer, in addition to the (A) component. The water-soluble polymer is not particularly limited in terms of type, and may be any of a cationic water-soluble polymer, an anionic water-soluble polymer, a nonionic water-soluble polymer, and an amphoteric water-soluble polymer.

Such any other water-soluble polymer is a polymer having the same (homopolymer) or different (copolymer) repeating constituent unit, and can be typically a compound having a weight average molecular weight (Mw) of 1000 or more. In a case where such any other water-soluble polymer is a copolymer, the form of the copolymer may be any of a block copolymer, a random copolymer, a graft copolymer, an alternate copolymer, and a periodic copolymer.

Examples of the cationic water-soluble polymer include polyethyleneimine (PEI), polyvinylamine, polyallylamine, polyvinylpyridine, and a polymer of cationic acrylamide.

Examples of the anionic water-soluble polymer include polyvinylsulfonic acid, polystyrenesulfonic acid, polyallylsulfonic acid, polymethallylsulfonic acid, poly(2-acrylamide-2-methylpropanesulfonic acid), polyisoprenesulfonic acid, polyacrylic acid, and polymethacrylic acid.

Examples of the nonionic water-soluble polymer include polyvinyl alcohol, polyacrylamide, poly N-vinylacetamide, polyamines, polyvinyl ethers (polyvinyl methyl ether, polyvinyl ethyl ether, polyvinylisobutyl ether, and the like), polyalkylene oxides (polyethylene oxide, polypropylene oxide, and the like), polyglycerin, polyethylene glycol, polypropylene glycol, alginic acid polyhydric alcohol ester, a water-soluble urea resin, a dextrin derivative, and casein.

Examples of the amphoteric water-soluble polymer include a copolymer of a vinyl monomer having an anionic group and a vinyl monomer having a cationic group, and a vinyl-based amphoteric polymer having a carboxybetaine group or a sulfobetaine group, and specifically include an acrylic acid/dimethylaminoethylmethacrylic acid copolymer and an acrylic acid/diethylaminoethylmethacrylic acid copolymer. Such any other water-soluble polymer may be used singly or in combinations of two or more kinds thereof. Such any other water-soluble polymer used here may be a synthetic product or a commercially available product.

### [(B) Inorganic Salt]

The polishing composition according to the present disclosure contains (B) an inorganic salt (hereinafter, also simply referred to as (B) component). It is considered that the (B) component is added to facilitate dispersing of the (A) component in the polishing composition and thus allow protection of a surface of an object to be polished with the (A) component to be efficiently performed and as a result, an excellent step elimination ability on an object to be polished is exhibited. It is also considered that the (B) component enhances the electrical conductivity of the polishing composition to enhance the polishing removal rate of an object to be polished (in particular, material having silicon-silicon bonds). It is considered that the ratio (selection ratio) of the polishing removal rate of a material having silicon-silicon bonds to the polishing removal rate of a material having silicon-nitrogen bonds is thus enhanced.

It is here considered that, in a case where an organic salt (a salt of an organic acid or a salt of an organic base) is used instead of the (B) component, interaction between the (A) component and the organic salt facilitates aggregation (association) of the (A) component to cause insufficient protection of a surface of an object to be polished and deteriorate the step elimination ability.

The inorganic salt is not particularly limited, and examples include a salt of a monovalent inorganic acid, a salt of a divalent inorganic acid, and a salt of a trivalent inorganic acid.

Examples of the monovalent inorganic acid include hydrochloric acid, nitric acid, and nitrous acid. Examples of the divalent inorganic acid include sulfuric acid, carbonic acid, sulfurous acid, thiosulfuric acid, and phosphonic acid. Examples of the trivalent inorganic acid include phosphoric acid, phosphomolybdic acid, phosphotungstic acid, and vanadic acid.

Examples of a salt of the monovalent inorganic acid, a salt of the divalent inorganic acid, and a salt of the trivalent inorganic acid include a lithium salt, a sodium salt, a potassium salt, a calcium salt, a magnesium salt, and an ammonium salt.

Still specific examples of the inorganic salt include sodium nitrate, potassium nitrate, ammonium nitrate, magnesium nitrate, calcium nitrate, sodium nitrite, potassium nitrite, lithium carbonate, sodium carbonate, potassium carbonate, magnesium carbonate, calcium carbonate, lithium hydrogen carbonate, sodium hydrogen carbonate, potassium hydrogen carbonate, ammonium carbonate, sodium sulfate, potassium sulfate, ammonium sulfate, calcium sulfate, magnesium sulfate, sodium sulfite, potassium sulfite, calcium sulfite, magnesium sulfite, potassium thiosulfate, lithium sulfate, magnesium sulfate, sodium thiosulfate, sodium hydrogen sulfite, ammonium hydrogen sulfate, lithium hydrogen sulfate, sodium hydrogen sulfate, potassium hydrogen sulfate, trilithium phosphate, tripotassium phosphate, trisodium phosphate, triammonium phosphate, disodium hydrogen phosphate, dipotassium hydrogen phosphate, diammonium hydrogen phosphate, sodium dihydrogen phosphate, potassium dihydrogen phosphate, and ammonium dihydrogen phosphate.

The (B) component may be used singly or in combinations of two or more kinds thereof. The (B) component used here may be a synthetic product or a commercially available product.

The (B) component is preferably an ammonium salt, more preferably at least one selected from the group consisting of ammonium nitrate, ammonium sulfate, ammonium hydrogen sulfate, triammonium phosphate, diammonium hydrogen phosphate, and ammonium dihydrogen phosphate, from the viewpoint that the effects of the present disclosure are efficiently obtained and from the viewpoint that the total concentration of sodium ions and potassium ions in the polishing composition is controlled within the range in the present disclosure. The (B) component is further preferably ammonium sulfate.

The concentration (content) of the (B) component in the polishing composition is not particularly limited, and is preferably 0.001% by mass or more, more preferably 0.003% by mass or more, further preferably 0.005% by mass or more, particularly preferably 0.01% by mass or more under the assumption that the total mass of the polishing composition is 100% by mass. The concentration (content) of the (B) component in the polishing composition is not particularly limited, and is preferably 5% by mass or less, more preferably 2% by mass or less, further preferably 1% by mass or less, particularly preferably 0.5% by mass or less under the assumption that the total mass of the polishing composition is 100% by mass.

In other words, the concentration (content) of the (B) component in the polishing composition is preferably 0.001% by mass or more and 5% by mass or less, more preferably 0.003% by mass or more and 2% by mass or less, further preferably 0.005% by mass or more and 1% by mass or less, particularly preferably 0.01% by mass or more and 0.5% by mass or less under the assumption that the total mass of the polishing composition is 100% by mass.

When the concentration (content) of the (B) component is in such a range, a polishing composition which is more excellent in step elimination ability and which more enhances the ratio (selection ratio) of the polishing removal rate of a material having silicon-silicon bonds to the polishing removal rate of a material having silicon-nitrogen bonds can be obtained. In a case where the polishing composition includes two or more such (B) components, the concentration (content) of the (B) component means the total amount of such components.

### [Electrical Conductivity of Polishing Composition]

The electrical conductivity (EC) of the polishing composition according to the present disclosure is 1 mS/cm or more and 50 mS/cm or less. In a case where the electrical conductivity of the polishing composition is less than 1 mS/cm, the polishing removal rate of an object to be polished (in particular, material having silicon-silicon bonds) is lowered and the ratio (selection ratio) of the polishing removal rate of a material having silicon-silicon bonds to the polishing removal rate of a material having silicon-nitrogen bonds is lowered. In this regard, in a case where the electrical conductivity of the polishing composition is more than 50 mS/cm, scratches increase.

The electrical conductivity of the polishing composition is preferably 1.5 mS/cm or more, more preferably 3 mS/cm or more, further preferably 5 mS/cm or more. The electrical conductivity of the polishing composition is preferably 30 mS/cm or less, more preferably 20 mS/cm or less, further preferably 10 mS/cm or less.

The electrical conductivity of the polishing composition can be adjusted depending on the type and the concentration of the (B) component, and the type, the concentration, and the like of a pH adjusting agent described later. The electrical conductivity of the polishing composition can be measured by a method described in Examples.

The polishing composition according to the present disclosure may further include an electrical conductivity adjusting agent for adjusting the electrical conductivity. The electrical conductivity adjusting agent is not particularly limited as long as it is any other component than the (B) component and the pH adjusting agent and has a function of adjusting the electrical conductivity. However, the electrical conductivity adjusting agent is preferably a compound not containing both sodium ions and potassium ions from the viewpoint that the total concentration of sodium ions and potassium ions is controlled within the range in the present disclosure.

### [Total Concentration of Sodium Ions and Potassium Ions]

The total concentration of sodium ions and potassium ions in the polishing composition according to the present disclosure is 1000 ppm by mass or less. In a case where the total concentration of sodium ions and potassium ions in the polishing composition is more than 1000 ppm by mass, the number of scratches on a surface of a polished object to be polished increases. In addition, sodium ions and potassium ions much remain on a semiconductor substrate, and the leakage current increases.

The total concentration of sodium ions and potassium ions in the polishing composition is preferably 100 ppm by mass or less, more preferably 20 ppm by mass or less, further preferably 10 ppm by mass or less. The lower limit value of the total concentration of sodium ions and potassium ions in the polishing composition may be 3 ppm by mass or more, 2 ppm by mass or more, or 1 ppm by mass or more. The total concentration of sodium ions and potassium ions in the polishing composition is particularly preferably 0 ppm by mass. In other words, a mode where the polishing composition does not contain sodium ions and potassium ions at all is particularly preferred.

The total concentration of sodium ions and potassium ions in the polishing composition can be controlled by the types, the concentrations, and the like of the (A) component and the (B) component. The total concentration of sodium ions and potassium ions in the polishing composition can be measured by an inductively coupled plasma emission spectroscopic analysis method (ICP-AES), and a detailed measurement method is described in Examples.

### [Abrasive Grains]

The polishing composition according to the present disclosure may include abrasive grains.

The abrasive grains are not particularly limited, and may be inorganic particles or organic particles. The inorganic particles are not particularly limited, and examples include particles including a metal oxide such as silica, alumina, ceria, or titania. The organic particles are not particularly limited, and examples include polymethyl methacrylate (PMMA) particles. In particular, the abrasive grains are preferably silica (silica abrasive grains), or colloidal silica (colloidal silica abrasive grains).

The shape of the abrasive grain is not particularly limited, and may be a spherical shape or a non-spherical shape. Specific examples of the non-spherical shape include various shapes, for example, polygonal columns such as a triangular column and a quadrangular column, a cylindrical shape, a bale shape in which the central portion of a cylinder is bulged as compared with an end portion, a donut shape in which the central portion of a disc penetrates, a plate-like shape, a so-called cocoon-like shape having a constriction at the central portion, a so-called associated spherical shape in which plural particles are integrated, a beaded shape in which plural particles are joined substantially in line, a so-called “konpeito” shape having plural protrusions on the surface, a rugby ball shape, and a needle-like shape finer than a rugby ball shape, but are not particularly limited thereto. In particular, a cocoon-like shape is preferred.

The average primary particle size of the abrasive grains is not particularly limited, and is preferably 5 nm or more, more preferably 7 nm or more, further preferably 10 nm or more, still further preferably 25 nm or more, particularly preferably 30 nm or more. In a case where the average primary particle size is in this range, the polishing removal rate is more enhanced. The average primary particle size of the abrasive grains is not particularly limited, and is preferably 120 nm or less, more preferably 80 nm or less, further preferably 50 nm or less, particularly preferably 40 nm or less. The average primary particle size of the abrasive grains can be calculated from the specific surface area of the abrasive grains, determined by a BET method.

The average secondary particle size of the abrasive grains is not particularly limited, and is preferably 10 nm or more, more preferably 20 nm or more, further preferably 30 nm or more, particularly preferably 50 nm or more. The average secondary particle size of the abrasive grains is not particularly limited, and is preferably 250 nm or less, more preferably 200 nm or less, further preferably 150 nm or less, particularly preferably 100 nm or less. The value of the average secondary particle size of the abrasive grains can be measured by a dynamic light scattering method.

The abrasive grains may be used singly or in combinations of two or more kinds thereof. The abrasive grains used here may be a synthetic product or a commercially available product.

Herein, the concentration (content) of the abrasive grains based on the total mass of the polishing composition is preferably 1% by mass or less from the viewpoint that the ratio (selection ratio) of the polishing removal rate of a material having silicon-silicon bonds to the polishing removal rate of a material having silicon-nitrogen bonds is more enhanced. The concentration (content) of the abrasive grains is more preferably less than 1% by mass, further preferably 0.5% by mass or less, particularly preferably 0.1% by mass or less. The most preferred mode is a mode in which the concentration (content) of the abrasive grains is 0% by mass, in other words, the abrasive grains are not included in the polishing composition at all. Here, in a case where the abrasive grains are included in the polishing composition, the lower limit value of the concentration (content) of the abrasive grains is more than 0% by mass.

### [pH and pH Adjusting Agent]

The pH of the polishing composition according to the present disclosure is 8 or more and 12 or less. In a case where the pH is less than 8 or the pH is more than 12, the polishing removal rate of material having silicon-silicon bonds is lowered.

The pH is preferably 8.5 or more, more preferably 9 or more. The upper limit of the pH is preferably 12 or less, more preferably 11.5 or less, further preferably 11 or less. In other words, the pH of the polishing composition according to the present disclosure is preferably 8.5 or more and 12 or less, more preferably 9 or more and 11.5 or less, further preferably 9 or more and 11 or less.

The (A) component and the (B) component in the present disclosure may serve as the pH adjusting agent. Here, if the above desired pH is not obtained by only the (A) component and the (B) component, the polishing composition according to the present disclosure may further include a pH adjusting agent other than the (A) component and the (B) component. The pH adjusting agent may be any of an acid such as an inorganic acid or an organic acid; and a base such as an inorganic base or an organic base. The pH adjusting agent may be used singly or in combinations of two or more kinds thereof.

Specific examples of the inorganic acid usable as the pH adjusting agent include hydrochloric acid, sulfuric acid, nitric acid, hydrofluoric acid, boric acid, carbonic acid, hypophosphorous acid, phosphorus acid, and phosphoric acid. Specific examples of the organic acid usable as the pH adjusting agent can include formic acid, acetic acid, propionic acid, butyric acid, valeric acid, 2-methylbutyric acid, n-hexanoic acid, 3,3-dimethylbutyric acid, 2-ethylbutyric acid, 4-methylpentanoic acid, n-heptanoic acid, 2-methylhexanoic acid, n-octanoic acid, 2-ethylhexanoic acid, benzoic acid, glycolic acid, salicylic acid, glyceric acid, oxalic acid, malonic acid, succinic acid, glutaric acid, adipic acid, pimelic acid, maleic acid, phthalic acid, malic acid, tartaric acid, citric acid, lactic acid, diglycolic acid, 2-furancarboxylic acid, 2,5-furandicarboxylic acid, 3-furancarboxylic acid, 2-tetrahydrofurancarboxylic acid, methoxyacetic acid, methoxyphenylacetic acid, phenoxyacetic acid, methanesulfonic acid, ethanesulfonic acid, and isethionic acid.

Specific examples of the base usable as the pH adjusting agent can include inorganic bases such as ammonia and organic bases such as tetramethylammonium hydroxide. The amount of addition of the pH adjusting agent is not particularly limited, and may be appropriately adjusted so that the polishing composition has a desired pH.

The pH of the polishing composition can be measured with, for example, a pH meter, and specifically can be measured by a method described in Examples.

### [Dispersing Medium]

The polishing composition according to the present disclosure preferably includes a dispersing medium for dispersing each component. Examples of the dispersing medium can include water; alcohols such as methanol, ethanol, and ethylene glycol; ketones such as acetone, and any mixture thereof. In particular, the dispersing medium is preferably water. In other words, according to a preferred mode of the present disclosure, the dispersing medium includes water. According to a more preferred mode of the present disclosure, the dispersing medium substantially includes water. Herein, the “substantially” means that any other dispersing medium than water can be included as long as the effects of the present disclosure are achieved. More specifically, the dispersing medium preferably includes 90% by mass or more and 100% by mass or less of water and 0% by mass or more and 10% by mass or less of any other dispersing medium than water, more preferably includes 99% by mass or more and 100% by mass or less of water and 0% by mass or more and 1% by mass or less of any other dispersing medium than water. The dispersing medium is most preferably water.

The dispersing medium is preferably water not containing impurities as much as possible from the viewpoint of not inhibiting the effects of the components included in the polishing composition. Specifically, the dispersing medium is more preferably ion exchange water (deionized water), pure water or ultrapure water obtained by removing impurity ions with an ion exchange resin and then removing foreign substances through a filter, or distilled water.

### [Other Components]

The polishing composition according to the present disclosure may further contain any known additive usable for polishing compositions, such as a complexing agent, an antiseptic agent, a surfactant, an antifungal agent, and/or an oxidizing agent as long as the effects of the present disclosure are not impaired. According to one embodiment of the present disclosure, the polishing composition may further contain an antifungal agent. In one embodiment of the present disclosure, the polishing composition is substantially constituted from (A) the at least one selected from the group consisting of a water-soluble polymer having a lactam structure and a water-soluble polymer having a cellulose structure, (B) the inorganic salt, the dispersing medium, and at least one selected from the group consisting of the pH adjusting agent and an antifungal agent. In one embodiment of the present disclosure, the polishing composition is substantially constituted from (A) the at least one selected from the group consisting of a water-soluble polymer having a lactam structure and a water-soluble polymer having a cellulose structure, the (B) inorganic salt, the dispersing medium, and the pH adjusting agent. Here, the “polishing composition is substantially constituted from (A) the at least one selected from the group consisting of a water-soluble polymer having a lactam structure and a water-soluble polymer having a cellulose structure, the (B) inorganic salt, dispersing medium, and at least one selected from the group consisting of the pH adjusting agent and an antifungal agent” means that the total content of (A) the at least one selected from the group consisting of a water-soluble polymer having a lactam structure and a water-soluble polymer having a cellulose structure, (B) the inorganic salt, the dispersing medium, the pH adjusting agent, and the antifungal agent is more than 99% by mass (the upper limit: 100% by mass) based on the total mass of the polishing composition. The polishing composition is preferably constituted from (A) the at least one selected from the group consisting of a water-soluble polymer having a lactam structure and a water-soluble polymer having a cellulose structure, (B) the inorganic salt, the dispersing medium, and the pH adjusting agent (the total content=100% by mass).

Examples of the antifungal agent (antiseptic agent) which can be added to the polishing composition according to the present disclosure include 1,2-benzoisothiazol-3 (2H)-one (BIT); isothiazoline-based antiseptic agents such as 2-methyl-4-isothiazolin-3-one and 5-chloro-2-methyl-4-isothiazolin-3-one; paraoxybenzoates; and phenoxyethanol. Such an antifungal agent may be used singly or in combinations of two or more kinds thereof.

### [Method for Producing Polishing Composition]

The method for producing the polishing composition according to the present disclosure is not particularly limited, and the polishing composition can be obtained by, for example, stirring and mixing the (A) component, the (B) component, and, if necessary, any other additive in the dispersing medium (for example, water). The detail of each of the components is as described above.

The temperature during mixing of each of the components is not particularly limited, and is preferably 10° C. or more and 40° C. or less, and heating may also be performed for increasing the rate of dissolution. The mixing time is also not particularly limited as long as uniform mixing can be made.

### [Object to be Polished]

A polishing composition according to one embodiment of the present disclosure can be applied to a known object to be polished which is not particularly limited and which is used in the CMP field. Therefore, an aspect of the object to be polished is not particularly limited, a layer being a flat-plate-like member is preferred, a substrate including the layer is more preferred, and a semiconductor substrate is further preferred. Examples include a substrate constituted from a single layer, and a substrate including a layer to be polished and any other layer (for example, a support layer or any other functional layer). Examples of the material constituting the object to be polished include, but not particularly limited thereto, a silicon-containing material and a metal-containing material (for example, a metal simple substance, metal oxide, and metal nitride). The material constituting the object to be polished may be adopted singly or in combinations of two or more kinds thereof.

Examples of the silicon-containing material include, but not particularly limited thereto, a material having a silicon-oxygen bond, a material having silicon-silicon bonds, and a material having silicon-nitrogen bonds. Examples of the material having a silicon-oxygen bond include, but not particularly limited thereto, silicon oxide, BD (black diamond: SiOCH), FSG (fluorosilicate glass), HSQ (hydrogen silsesquioxane), CYCLOTENE, SiLK, and MSQ (Methyl silsesquioxane). Examples of the object to be polished having silicon-silicon bonds include, but not particularly limited thereto, polycrystalline silicon (polysilicon, Poly-Si), amorphous silicon (a-Si), monocrystalline silicon, n-type doped monocrystalline silicon, and p-type doped monocrystalline silicon, and Si-type alloys such as SiGe. Examples of the material having silicon-nitrogen bonds include, but not particularly limited thereto, silicon nitride and silicon carbonitride (SiCN).

Among such silicon-containing materials, the material having silicon-silicon bonds is preferred, and amorphous silicon is more preferred. The object to be polished preferably includes not only the material having silicon-silicon bonds, but also the material having silicon-nitrogen bonds. A film including the material having silicon-nitrogen bonds can be used as a stop film.

### [Polishing Method]

As described above, the polishing composition according to the present disclosure is suitably used for polishing an object to be polished containing a material having silicon-silicon bonds. Accordingly, the present disclosure provides a polishing method including a step of polishing an object to be polished containing a material having silicon-silicon bonds with the polishing composition according to the present disclosure. The present disclosure provides a method for producing a substrate, the method including polishing an object to be polished containing a material having silicon-silicon bonds by the polishing method according to the present disclosure.

The polishing apparatus used here can be a common polishing apparatus which is equipped with a holder for retaining a substrate or the like having an object to be polished and a motor changeable in number of rotations, and the like, and which has a platen to which a polishing pad (polishing cloth) can be attached.

The type of the polishing pad used in the polishing method and the method for producing a semiconductor substrate, according to the present disclosure, is not particularly limited, and, for example, an expanded polyurethane type, a non-woven cloth type, or a suede type can be used.

The shore D hardness of the polishing pad is preferably 30 or more. When the shore D hardness is 30 or more, the pressure applicable to an object to be polished can be increased and the polishing removal rate is more enhanced. The shore D hardness of the polishing pad is more preferably 40 or more, further preferably 50 or more. The shore D hardness of the polishing pad is preferably 90 or less, more preferably 80 or less, further preferably 70 or less. When the shore D hardness is 90 or less, the polishing pad can well follow an object to be polished surface during polishing and polishing can be stably performed. The shore D hardness can be measured by a method described in JIS K 7215:1986.

Among polishing conditions, for example, the rotational speed of a platen is, for example, preferably 10 rpm (0.17 s⁻¹) or more and 500 rpm (8.33 s⁻¹). The pressure (polishing pressure) applied to a substrate having an object to be polished is preferably 0.5 psi (3.4 kPa) or more and 10 psi (68.9 kPa). The method for supplying the polishing composition to the polishing pad is also not particularly limited, and, for example, a continuously supplying method with a pump or the like is adopted. The amount of this supplying is not limited, and a surface of the polishing pad is preferably always covered with the polishing composition according to the present disclosure.

After completion of polishing, a substrate is washed in flowing water and water droplets attached onto the substrate are blown away with a spin dryer or the like, thereby providing a substrate containing a material having silicon-silicon bonds.

The polishing composition according to the present disclosure may be of one-liquid-type, or of multi-liquid type including two-liquid type. The polishing composition according to the present disclosure may also be prepared by diluting a stock solution of the polishing composition with a dilution liquid such as water to, for example, two times or more and 10 times or less.

A polishing composition according to more preferred one aspect of the present disclosure is suitably used for polishing an object to be polished having a material having silicon-silicon bonds, in which the material is embedded on a substrate having a depressed portion so as to cover the depressed portion. In other words, the present disclosure provides a polishing method including polishing a material having silicon-silicon bonds, in which the material is embedded on a substrate having a depressed portion so as to cover the depressed portion, with the polishing composition of the present disclosure.

Specific examples of the material having silicon-silicon bonds, in which the material is embedded on a substrate having a depressed portion so as to cover the depressed portion, include the above-described materials having silicon-silicon bonds, and amorphous silicon is more preferred. Here, a stop film may be formed between a film including the material having silicon-silicon bonds and the substrate. Examples of the material of such a stop film include a material having silicon-nitrogen bonds, preferably include silicon nitride.

### [Step Elimination Ability]

A polishing method with a polishing composition according to preferred one embodiment of the present disclosure includes polishing a surface of an object to be polished containing a material having silicon-silicon bonds, with the polishing composition. Thus, polishing characteristics of the object to be polished can be more enhanced. In particular, in a case where a step due to multi-layering of wires, or the like, for example, an initial step is generated on a surface of a substrate, the step elimination ability can be enhanced. This step elimination ability can be evaluated with the step elimination efficiency determined as “(the amount (Å) of a height portion eliminated of a step, by polishing in a certain polishing process (in one depressed portion, the height (Å) from the lowest portion of the depressed portion to the uppermost portion of a protruded portion constituting the depressed portion)) (the amount of step elimination) (Å)/(the total amount of polishing in the polishing process (the distance (Å) from the height of the uppermost portion of the protruded portion before polishing to the height of the uppermost portion of the protruded portion after polishing))”. As such a value is closer to 1, only an upper surface of the protruded portion can be selectively polished to make the polishing efficiency more excellent. The step elimination efficiency is preferably 0.15 (15%) or more, more preferably 0.2 (20%) or more, further preferably 0.25 (25%) or more, particularly preferably 0.3 (30%) or more in the case of polishing in polishing conditions of, for example, a polishing pressure of 2.5 psi (17.2 kPa) and a number of platen rotations of 90 rpm (1.5 s⁻¹). Herein, 1 Å-0.1 nm is satisfied.

### [Selection Ratio]

The polishing composition according to the present disclosure can enhance the ratio (selection ratio, polishing removal rate of material having silicon-silicon bonds/polishing removal rate of material having silicon-nitrogen bonds) of the polishing removal rate of a material having silicon-silicon bonds to the polishing removal rate of a material having silicon-nitrogen bonds.

In the present disclosure, the ratio of the polishing removal rate of a material having silicon-silicon bonds to the polishing removal rate of a material having silicon-nitrogen bonds is preferably 150 or more, more preferably 200 or more, further preferably 500 or more, particularly preferably 1000 or more.

### [Scratch]

The polishing composition according to the present disclosure can reduce scratches on a polished object to be polished (in particular, amorphous silicon) surface.

In some embodiments of the present disclosure, the number of scratches on a polished object to be polished (in particular, amorphous silicon) surface is preferably less than 30, more preferably less than 20, further preferably less than 10, particularly preferably less than 5. The lower limit of the number of scratches is 0. Herein, the “scratch” refers to a scratch having a size of 50 nm or more on a surface of a polished object to be polished. Measurement of the number of scratches can be performed by a method described in Examples.

Although embodiments of the present disclosure are described in detail, it is clear that these embodiments are descriptive and illustrative and are not limiting and the scope of the present disclosure is to be interpreted by the accompanying claims.

The present disclosure encompasses the following aspects and modes.
[1] A polishing composition comprising
(A) at least one selected from the group consisting of a water-soluble polymer having a lactam structure and a water-soluble polymer having a cellulose structure, and
(B) an inorganic salt, wherein
an electrical conductivity is 1 mS/cm or more and 50 mS/cm or less,
a total concentration of sodium ions and potassium ions is 1000 ppm by mass or less, and a pH is 8 or more and 12 or less:
[2] The polishing composition according to [1], wherein the water-soluble polymer having a lactam structure is at least one selected from the group consisting of polyvinylpyrrolidone, polyvinylcaprolactam, polyvinylvalerolactam, polyvinyllaurolactam, and polyvinylpiperidone:
[3] The polishing composition according to [1], wherein the water-soluble polymer having a cellulose structure is at least one selected from the group consisting of hydroxymethylcellulose, hydroxyethylcellulose, methylcellulose, and carboxymethylcellulose:
[4] The polishing composition according to any of [1] to [3], wherein the (B) inorganic salt is at least one selected from the group consisting of ammonium nitrate, ammonium sulfate, ammonium hydrogen sulfate, triammonium phosphate, diammonium hydrogen phosphate, and ammonium dihydrogen phosphate:
[5] The polishing composition according to any of [1] to [4], further comprising a dispersing medium:
[6] The polishing composition according to any of [1] to [5], wherein a concentration of abrasive grains based on a total mass of the polishing composition is 1% by mass or less:
[7] The polishing composition according to any of [1] to [6], for use in the polishing of an object to be polished including a material having silicon-silicon bonds:
[8] The polishing composition according to [7], wherein the material having silicon-silicon bonds is amorphous silicon:
[9] The polishing composition according to [7] or [8], wherein the object to be polished further includes a material having silicon-nitrogen bonds:
[10] A polishing method comprising polishing a material having silicon-silicon bonds, in which the material is embedded on a substrate having a depressed portion so as to cover the depressed portion, with the polishing composition according to any of [1] to [9].

### EXAMPLES

The present disclosure is described in further detail with reference to the following Examples and Comparative Examples. However, the technical scope of the present disclosure is not limited to only the following Examples. Unless particularly noted, “%” and “part(s)” respectively mean “% by mass” and “part(s) by mass”.

### <Weight Average Molecular Weight of (A) Component>

The weight average molecular weight of the (A) component was measured by gel permeation chromatography (GPC) with polyethylene glycol as a standard substance. Detailed conditions are as described below:
GPC apparatus: manufactured by Shimadzu Corporation
Model: Prominence+ELSD detector (ELSD-LTII)
Column: VP-ODS (manufactured by Shimadzu Corporation)
Mobile phase A: MeOH
Mobile phase B: aqueous 1% acetic acid solution
Flow rate: 1 mL/min
Detector: ELSD temp. 40° C., Gain 8, N2 GAS 350 kPa
Oven temperature: 40° C.
Amount of injection: 40 μl.

### <pH of Polishing Composition>

The pH of the polishing composition was measured as a value at 25° C. with a pH meter (Model number: LAQUA (registered trademark) manufactured by Horiba Ltd.).

### <Electrical Conductivity of Polishing Composition>

The electrical conductivity (EC) of the polishing composition was measured with a desktop-type electrical conductivity meter (Model number: DS-71 manufactured by Horiba Ltd.).

### <Total Concentration of Sodium Ions and Potassium Ions>

The total concentration of sodium ions and potassium ions in the polishing composition was measured with the following apparatus and conditions, by an inductively coupled plasma emission spectroscopic analysis method (ICP-AES):
ICP-AES apparatus: manufactured by Shimadzu Corporation
Model: ICPS-8100
Measurement method: standard addition method
Measurement object: Na⁺, K⁺
High-frequency output: 1.2 kW
Height of torch observed: 11.0 mm
Plasma gas: 14.0 L/min
Auxiliary gas: 1.20 L/min
Carrier gas: 0.70 L/min.

### <Average Primary Particle Size of Abrasive Grains>

The average primary particle size of the abrasive grains was calculated from the specific surface area of a silica particle according to a BET method, as measured with “Flow Sorb II 2300” manufactured by Micromeritics Instrument Corporation, and the density of the abrasive grains.

### <Average Secondary Particle Size of Abrasive Grains>

The average secondary particle size of the abrasive grains was measured as the volume average particle size with a laser light scattering measurement apparatus Zetasizer Ultra (manufactured by Malvern Panalytical Ltd.).

### <Zeta Potential of Abrasive Grains>

The zeta potential of the abrasive grains in the polishing composition was measured with a zeta potential measurement apparatus (equipment name “ELS-Z2”) manufactured by Otsuka Electronics Co., Ltd.

### <Components of Polishing Composition>

The details of the abrasive grains and the (A) component used for preparation of the polishing composition are as follows:
Abrasive grain 1: colloidal silica, average primary particle size 35 nm, average secondary particle size 70 nm
Abrasive grain 2: colloidal silica, average primary particle size 90 nm, average secondary particle size 220 nm
PVP: polyvinylpyrrolidone, Mw: 45,000
HEC: hydroxyethylcellulose, Mw: 90,000

### <Object to be Polished>

A silicon wafer (a-Si substrate, diameter 300 mm) where an amorphous silicon film having a thickness of 2000 Å was formed by CVD on the wafer and a silicon wafer (SiN substrate, diameter 300 mm) where a SiN film having a thickness of 2500 Å was formed on the wafer were prepared as an object to be polished (object to be polished for polishing removal rate evaluation) used for evaluation of the polishing removal rate.

An object to be polished used for evaluation of the step elimination ability (object to be polished for step elimination ability evaluation), used here, was a silicon wafer where an amorphous silicon film having a thickness of 3000 Å and an initial step of 800 Å was formed on a surface of the wafer.

### Example 1

Three hundred g of ultrapure water was added to 0.5 g of polyvinylpyrrolidone as the (A) component and the resultant was stirred. Next, 0.5 g of ammonium sulfate as the (B) component and 300 g of ultrapure water were added. Furthermore, ammonia as the pH adjusting agent was added in an amount so that the final pH of the polishing composition was 10.0, and ultrapure water was added so that the total mass of the polishing composition was 1 kg, thereby preparing polishing composition 1.

### Example 2

Polishing composition 2 was prepared in the same manner as in Example 1 except that the amount of addition of ammonium sulfate was changed to 4.8 g.

### Example 3

Polishing composition 3 was prepared in the same manner as in Example 2 except that sulfonic acid-modified colloidal silica as abrasive grain 1 was further added in an amount so that the final concentration was 0.1% by mass.

### Example 4

Polishing composition 4 was prepared in the same manner as in Example 2 except that 0.1 g of hydroxyethylcellulose was added instead of polyvinylpyrrolidone.

### Example 5

Polishing composition 5 was prepared in the same manner as in Example 4 except that sulfonic acid-modified colloidal silica as abrasive grain 1 was further added in an amount so that the final concentration was 0.5% by mass.

### Example 6

Polishing composition 6 was prepared in the same manner as in Example 4 except that sulfonic acid-modified colloidal silica as abrasive grain 1 was further added in an amount so that the final concentration was 0.1% by mass, and the amount of addition of ammonium sulfate was changed to 19.2 g.

### Comparative Example 1

Polishing composition comparison 1 was prepared in the same manner as in Example 3 except that polyvinylpyrrolidone was not used.

### Comparative Example 2

Polishing composition comparison 2 was prepared in the same manner as in Example 6 except that the amount of addition of hydroxyethylcellulose was changed to 0.5 g and 4.8 g of ammonium citrate was added instead of ammonium sulfate.

### Comparative Example 3

Polishing composition comparison 3 was prepared in the same manner as in Example 3 except that 1.0 g of choline chloride was added instead of ammonium sulfate.

### Comparative Example 4

Three hundred g of ultrapure water was added to 0.5 g of polyvinylpyrrolidone as the (A) component and the resultant was stirred. Next, sulfonic acid-modified colloidal silica as abrasive grain 2 was added in an amount so that the final concentration was 1.5% by mass, and furthermore ammonia was added in an amount so that the final concentration was 0.25% by mass. Thereafter, ultrapure water was further added so that the total mass of the polishing composition was 1 kg, thereby preparing polishing composition comparison 4.

### Comparative Example 5

Polishing composition comparison 5 was prepared in the same manner as in Comparative Example 4 except that potassium hydroxide (KOH) was added instead of ammonia in an amount so that the final concentration was 0.19% by mass.

### Comparative Example 6

Polishing composition comparison 6 was prepared in the same manner as in Comparative Example 4 except that sulfonic acid-modified colloidal silica as abrasive grain 1 was added instead of abrasive grain 2 in an amount so that the final concentration was 0.1% by mass.

### [Polishing Conditions]

The polishing compositions of Examples and Comparative Examples were used to polish an object to be polished for polishing removal rate evaluation in the following polishing conditions:
Polishing apparatus: F-REX 300E manufactured by Ebara Corporation
Polishing pad: IK4250H (shore D hardness: 60) manufactured by Du Pont
Polishing time: 20 seconds
Pressure of platen: 2.5 psi (17.2 kPa)
Number of rotations of platen: 60 rpm
Number of rotations of carrier: 63 rpm
Supply rate of polishing composition: 200 ml/min

### [Measurement of Polishing Removal Rate]

The polishing removal rate (polishing rate) of the object to be polished was calculated by the following expression.

$$Polisiong removal rate [ Å / min ] = ( Film thickness [ Å ] before polishing - Film thickness [ Å ] after polishing ) / Polishing time [ min ] \qquad [ Expression 1 ]$$

The thicknesses before and after polishing of the object to be polished were determined with a light interference type film thickness measurement apparatus (Model number: A-SET F5X manufactured by KLA-Tencor), and the difference therebetween was divided by the polishing time to calculate the polishing removal rate. The selection ratio was determined by dividing the polishing removal rate of amorphous silicon by the polishing removal rate of silicon nitride.

### [Number of Scratches]

The number of scratches with sizes of 50 nm or more on a surface of a polished object to be polished obtained after polishing of the above object to be polished (amorphous silicon) for polishing removal rate measurement was evaluated. Specifically, the number of scratches with sizes of 50 nm or more on the entire surface of the object to be polished (except for a portion of 5 mm from the periphery) was measured with a defect detection apparatus (wafer inspection apparatus) “Surfscan SP5” manufactured by KLA-Tencor (KLA-TENCOR).

### [Step Elimination Ability (Step Elimination Efficiency)]

The above-prepared object to be polished for step elimination ability evaluation was cut to a size of 60 mm×60 mm, and a surface thereof was polished by only 1000 Å in the following polishing conditions. The value of the step elimination efficiency was obtained as the value by dividing the amount of step elimination, as determined by subtracting the step after polishing from the initial step, (initial step-step after polishing), by the amount of polishing (1000 Å), as expressed in terms of percentage (see the following expression). The step was measured with an atomic force microscope (AFM, manufactured by Bruker, Dimention ICON). The step elimination efficiency is more preferably closer to a numerical value of 100%:
Polishing apparatus: desktop polishing machine EJ-380 IN manufactured by ENGIS JAPAN Corporation
Polishing pad: IK4250H (shore D hardness: 60) manufactured by Du Pont
Pressure of platen: 2.5 psi (17.2 kPa)
Number of rotations of platen: 90 rpm
Supply rate of polishing composition: 20 ml/min.

$$Step elimination efficiency ( \% ) = ( Amount of step elemination / Amount of polishing ) \times 100 \qquad [ Expression 2 ]$$

The constitutions of the polishing compositions of Examples and Comparative Examples are shown in Table 1 below, and the results of each evaluation described above are shown in Table 2.

TABLE 1

| | | | | | | | | | | | Total | | |
|---|---|---|---|---|---|---|---|---|---|---|---|---|---|
| | | | | | | | | | | | concen- | | |
| | | Abrasive grains | | | | | | | | | tration | | |
| | | Average | | | (A) Component | | | (B) Component | | | of Na | | |
| | | secondary | | Concen- | | | Concen- | | Concen- | | ion and | | |
| | Compo- | particle | Zeta | tration | | | tration | | tration | pH | K ion | | |
| | sition | size | potential | (% by | | | (% by | | (% by | adjusting | (ppm by | | EC |
| | No. | (nm) | (mV) | mass) | Type | Mw | mass) | Type | mass) | agent | mass) | pH | (mS/cm) |
| Example | 1 | — | — | — | PVP | 45,000 | 0.05 | Ammonium | 0.05 | NH₃ | 5 | 10.0 | 1.5 |
| 1 | | | | | | | | sulfate | | | | | |
| Example | 2 | — | — | — | PVP | 45,000 | 0.05 | Ammonium | 0.48 | NH₃ | 5 | 10.0 | 7.9 |
| 2 | | | | | | | | sulfate | | | | | |
| Example | 3 | 70 | −40 | 0.1 | PVP | 45,000 | 0.05 | Ammonium | 0.48 | NH | 5 | 10.0 | 7.9 |
| 3 | | | | | | | | sulfate | | | | | |
| Example | 4 | — | — | — | HEC | 90,000 | 0.01 | Ammonium | 0.48 | NH₃ | 5 | 10.0 | 7.8 |
| 4 | | | | | | | | sulfate | | | | | |
| Example | 5 | 70 | −40 | 0.5 | HEC | 90,000 | 0.01 | Ammonium | 0.48 | NH₃ | 5 | 10.0 | 7.8 |
| 5 | | | | | | | | sulfate | | | | | |
| Example | 6 | 70 | −40 | 0.1 | HEC | 90,000 | 0.01 | Ammonium | 1.92 | NH₃ | 5 | 10.0 | 23.0 |
| 6 | | | | | | | | sulfate | | | | | |
| Compar- | Compar- | 70 | −40 | 0.1 | — | — | | Ammonium | 0.48 | NH₃ | 5 | 10.0 | 7.8 |
| ative | ison | | | | | | | sulfate | | | | | |
| Example 1 | 1 | | | | | | | | | | | | |
| Compar- | Compar- | 70 | −40 | 0.1 | HEC | 90,000 | 0.05 | Ammonium | 0.48 | NH₃ | 5 | 10.0 | 8.0 |
| ative | ison | | | | | | | citrate | | | | | |
| Example 2 | 2 | | | | | | | | | | | | |
| Compar- | Compar- | 70 | −40 | 0.1 | PVP | 45,000 | 0.05 | Choline | 0.1 | NH₃ | 5 | 10.0 | 1.5 |
| ative | ison | | | | | | | chloride | | | | | |
| Example 3 | 3 | | | | | | | | | | | | |
| Compar- | Compar- | 220 | −40 | 1.5 | PVP | 45,000 | 0.05 | — | — | NH₃ | 5 | 10.0 | 0.8 |
| ative | ison | | | | | | | | | 0.25% | | | |
| Example 4 | 4 | | | | | | | | | by | | | |
| | | | | | | | | | | mass | | | |
| Compar- | Compar- | 220 | −40 | 1.5 | PVP | 45,000 | 0.05 | — | — | KOH | 2000 | 10.0 | 2.1 |
| ative | ison | | | | | | | | | 0.19% | | | |
| Example 5 | 5 | | | | | | | | | by | | | |
| | | | | | | | | | | mass | | | |
| Compar- | Compar- | 70 | −40 | 0.1 | PVP | 45,000 | 0.05 | — | — | NH₃ | 5 | 10.0 | 0.8 |
| ative | ison | | | | | | | | | 0.25% | | | |
| Example 6 | 6 | | | | | | | | | by | | | |
| | | | | | | | | | | mass | | | |

TABLE 2

| | | Polishing removal rate | | Selection | Number of | Step |
|---|---|---|---|---|---|---|
| | Composition | (Å/min) | | ratio | scratches | elimination |
| | No. | a-Si | SiN | a-Si/SiN | (scratches) | efficiency (%) |
| Example 1 | 1 | 1125 | 1 | 1125 | 1 | 43 |
| Example 2 | 2 | 1380 | 1 | 1380 | 1 | 42 |
| Example 3 | 3 | 1459 | 6 | 243 | 2 | 42 |
| Example 4 | 4 | 1290 | 1 | 1290 | 1 | 41 |
| Example 5 | 5 | 1766 | 9 | 196 | 3 | 44 |
| Example 6 | 6 | 1542 | 6 | 257 | 3 | 42 |
| Comparative | Comparison | 2430 | 8 | 304 | 2 | 21 |
| Example 1 | 1 | | | | | |
| Comparative | Comparison | 1012 | 7 | 145 | 3 | 34 |
| Example 2 | 2 | | | | | |
| Comparative | Comparison | 1120 | 8 | 140 | 3 | 27 |
| Example 3 | 3 | | | | | |
| Comparative | Comparison | 1450 | 32 | 45 | 19 | 31 |
| Example 4 | 4 | | | | | |
| Comparative | Comparison | 1854 | 49 | 38 | 23 | 39 |
| Example 5 | 5 | | | | | |
| Comparative | Comparison | 1100 | 6 | 183 | 3 | 32 |
| Example 6 | 6 | | | | | |

As clear from Table 2 above, it has been found that the polishing compositions of Examples have an excellent step elimination ability on an object to be polished, enhance the ratio (selection ratio) of the polishing removal rate of a material having silicon-silicon bonds to the polishing removal rate of a material having silicon-nitrogen bonds, and are also excellent in scratch reduction on a surface of a polished object to be polished, as compared with the polishing compositions of Comparative Examples.

1. A polishing composition comprising
(A) at least one selected from the group consisting of a water-soluble polymer having a lactam structure and a water-soluble polymer having a cellulose structure, and
(B) an inorganic salt, wherein
an electrical conductivity is 1 mS/cm or more and 50 mS/cm or less,
a total concentration of sodium ions and potassium ions is 1000 ppm by mass or less, and
a pH is 8 or more and 12 or less.

2. The polishing composition according to claim 1, wherein the water-soluble polymer having a lactam structure is at least one selected from the group consisting of polyvinylpyrrolidone, polyvinylcaprolactam, polyvinylvalerolactam, polyvinyllaurolactam, and polyvinylpiperidone.

3. The polishing composition according to claim 1, wherein the water-soluble polymer having a cellulose structure is at least one selected from the group consisting of hydroxymethylcellulose, hydroxyethylcellulose, methylcellulose, and carboxymethylcellulose.

4. The polishing composition according to claim 1, wherein the (B) inorganic salt is at least one selected from the group consisting of ammonium nitrate, ammonium sulfate, ammonium sulfate, ammonium hydrogen sulfate, triammonium phosphate, diammonium hydrogen phosphate, and ammonium dihydrogen phosphate.

5. The polishing composition according to claim 1, further comprising a dispersing medium.

6. The polishing composition according to claim 1, wherein a concentration of abrasive grains based on a total mass of the polishing composition is 1% by mass or less.

7. The polishing composition according to claim 1, for use in the polishing of an object to be polished including a material having silicon-silicon bonds.

8. The polishing composition according to claim 7, wherein the material having silicon-silicon bonds is amorphous silicon.

9. The polishing composition according to claim 7, wherein the object to be polished further includes a material having silicon-nitrogen bonds.

10. A polishing method comprising polishing a material having silicon-silicon bonds, in which the material is embedded on a substrate having a depressed portion so as to cover the depressed portion, with the polishing composition according to claim 1.
